(19) United States
(12) Patent Application Publication
(10) Pub. No.: US 2010/0313645 A1
(43) Pub. Date: Dec. 16, 2010

(54) TEST PROCEDURE TO DETERMINE CONCENTRATION AND RELATIVE DISTRIBUTION OF SIZED PARTICLES IN A DRILLING FLUID

(75) Inventors: Aaron A. Doman, Youngsville, LA (US); Jake M. Garber, Youngsville, LA (US); Philip E. Herrera, Katy, TX (US); Frank Butler, Lafayette, LA (US); Toby Pierce, Houston, TX (US); Tim Browning, Metairie, LA (US); John Riddell Smith, Katy, TX (US); Frederick B. Growcock, Houston, TX (US)

Correspondence Address: OSHA LIANG/MI, TWO HOUSTON CENTER, 909 FANNIN STREET, SUITE 3500, HOUSTON, TX, 77010, US

(73) Assignee: M-I L.L.C., Houston, TX (US)

(21) Appl. No.: 12/918,031

(22) PCT Filed: Feb. 18, 2009
(86) PCT No.: PCT/US09/34401

§ 371 Date: Aug. 17, 2010

Related U.S. Application Data
(60) Provisional application No. 61/029,537, filed on Feb. 18, 2008.
(60) Provisional application No. 61/030,905, filed on Feb. 22, 2008.

(51) Int. Cl. E21B 43/38; G01N 15/02

(52) U.S. Cl. 73/152.04; 73/865.5

(57) ABSTRACT

A method of determining a particle size distribution in a wellbore fluid including collecting a volume of mud from a vibratory separator, sampling a volume of the collected mud, and testing the volume of collected mud with a test kit to determine the concentration of a sized additive in the mud is disclosed. A system for determining particle size distribution of a fluid, the system including a vibratory separator, a meter configured to receive a separated material from the vibratory separator, a counter configured to count the number of loads collected by the meter, a test kit including a sieve and a measuring tube, and a centrifuged configured to receive the measuring tube is also disclosed.

### BACKGROUND

1. Field

Embodiments disclosed herein generally relate to test procedures and apparatus for determining the concentration, quantity, and relative distribution of sized particles in drilling fluids. More specifically, embodiments disclosed herein relate to test procedures and apparatus for determining an amount of an unknown quantity of product (e.g., loss prevention material) being recovered and added to an active mud system.

2. Background Art

During the drilling of a wellbore, various fluids are typically used in the well for a variety of functions. The fluids may be circulated through a drill pipe and drill bit into the wellbore, and then may subsequently flow upward through wellbore to the surface. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

Wellbore fluids may also be used to provide sufficient hydrostatic pressure in the well to prevent the influx and efflux of formation fluids and wellbore fluids, respectively. When the pore pressure (the pressure in the formation pore space provided by the formation fluids) exceeds the pressure in the open wellbore, the formation fluids tend to flow from the formation into the open wellbore. Therefore, the pressure in the open wellbore is typically maintained at a higher pressure than the pore pressure. While it is highly advantageous to maintain the wellbore pressures above the pore pressure, on the other hand, if the pressure exerted by the wellbore fluids exceeds the fracture resistance of the formation, a formation fracture and thus induced mud losses may occur. Further, with a formation fracture, when the wellbore fluid in the annulus flows into the fracture, the loss of wellbore fluid may cause the hydrostatic pressure in the wellbore to decrease, which may in turn also allow formation fluids to enter the wellbore. As a result, the formation fracture pressure typically defines an upper limit for allowable wellbore pressure in an open wellbore while the pore pressure defines a lower limit. Therefore, a major constraint on well design and selection of drilling fluids is the balance between varying pore pressures and formation fracture pressures or fracture gradients though the depth of the well.

A particularly challenging situation arises in depleted reservoirs, in which high pressured formations are neighbored by or inter-bedded with normally or abnormally pressured zones. For example, high permeability pressure depleted sands may be neighbored by high pressured low permeability rocks, such as shale or high pressure sands. This can make the drilling of certain depleted zones nearly impossible because the mud weight required to support the shale exceeds the fracture resistance of the pressure depleted sands and silts.

Thus, wellbore strengthening techniques, ranging from use of cements, resins, casing drilling, and managed pressure drilling, etc, have seen recent increases in application and further development. In the drilling of the depleted zones described above, wellbore strengthening techniques have been used in hopes of increasing the fracture resistance of weaker formation, which may allow for more efficient and economic drilling.

Another wellbore strengthening technique includes using a wellbore fluid comprising bridging materials (or “stress cage solids” as frequently referred to in the art) carried by a carrier fluid to bridge fractures induced in a wellbore wall. Optionally, a bridge sealing material may also be included in the wellbore for assisting in the sealing of the bridge. Such methods of treating and/or strengthening a wellbore may be applied in wellbore drilled with oil- or water-based fluids. The concentration of bridging particles may be carried at an overly high concentration to ensure that appropriately sized particles do bridge and seal the fracture before the fracture grows in length well beyond the well. The ability of the particles to bridge and seal the fracture is highly dependent upon the particle size distribution of the particles.

Accordingly, there exists a continuing need for apparatus and procedures for determining the relative size distribution of particles added to the fluid during operation.

### SUMMARY

In one aspect, embodiments disclosed herein relate to a method of determining a particle size distribution in a wellbore fluid including collecting a volume of mud from a vibratory separator, sampling a volume of the collected mud, and testing the volume of collected mud with a test kit to determine the concentration of a sized additive in the mud.

In another aspect, embodiments disclosed herein relate to a system for determining particle size distribution of a fluid, the system including a vibratory separator, a meter configured to receive a separated material from the vibratory separator, a counter configured to count the number of loads collected by the meter, a test kit including a sieve and a measuring tube, and a centrifuged configured to receive the measuring tube.

Other aspects and advantages of the invention will be apparent from the following description and the appended claims.

### BRIEF DESCRIPTION OF DRAWINGS

FIG. 1 shows a wet-sieving apparatus in accordance with embodiments of the present disclosure.

FIG. 2 shows a test kit for a wet-sieving system in accordance with embodiments of the present disclosure.

FIG. 3 shows a perspective view of a meter of a wet-sieving system in accordance with embodiments of the present disclosure.

FIG. 4 shows a side view of a meter of a wet-sieving system in accordance with embodiments of the present disclosure.

FIG. 5 shows a counter of a wet-sieving system in accordance with embodiments of the present disclosure.

FIG. 6 shows a particle size distribution of two bridging additives in accordance with embodiments of the present disclosure.

FIG. 7 shows normalized measured data points for a bulk density determination in accordance with embodiments of the present disclosure.

FIGS. 8A-8D show a portable wet-sieving device and its components in accordance with embodiments of the present disclosure.

FIGS. 9A and 9B show a portable wet-sieving device and its components in accordance with embodiments of the present disclosure.

FIGS. 10A and 10B show a portable wet-sieving device and its components in accordance with embodiments of the present disclosure.

FIGS. 11A-11C show sieves suitable for use in a portable wet-sieving device in accordance with embodiments of the present disclosure.

FIGS. 12A-12E show the results of a Coulter PSD analysis versus a wet-sieve analysis performed in accordance with embodiments of the present disclosure.

FIGS. 13A-13E show the results of a dry weight analysis versus a wet-sieve analysis performed in accordance with embodiments of the present disclosure.

FIGS. 14A-14C show concentration of LPM material determined by a wet-sieving analysis performed in accordance with embodiments of the present disclosure.

### DETAILED DESCRIPTION

In one aspect, embodiments of the present disclosure relate to test procedures and apparatus for determining the concentration, quantity, and relative distribution of sized particles in drilling fluids. In another aspect, embodiments of the present disclosure relate to test procedures and apparatus for determining an amount of an unknown quantity of product (e.g., low permeability material) being recovered and added to an active mud system. In yet another aspect, embodiments of the present disclosure relate to wet sieve tests or procedures for determining proper adjustments to fluid additives necessary to maintain proper particle size distribution of a drilling fluid or mud.

In other aspects, embodiments disclosed herein relate to monitoring and maintaining proper particle size distribution of a mud during wellbore strengthening techniques during drilling. For example, during hoop stress enhancement techniques, as disclosed in, for example, Provisional Application 60/953,387, filed Aug. 1, 2007, incorporated by reference herein in its entirety, shallow fractures in a formation with elevated wellbore pressure are induced and large particles are simultaneously forced into the fractures to keep them propped and in a stressed state. When whole mud is treated with relatively large proppant particles, the particle size distribution of the mud should be monitored continuously. As such, embodiments disclosed herein provide a method, specifically, a wet sieve analysis, that can be used to provide a trend analysis of the particles in the mud to help maintain the correct concentration and distribution of the proppant material.

Strengthening of a wellbore through a low permeability formation may be achieved by using a wellbore fluid comprising bridging materials (or “stress cage solids” as frequently referred to in the art) carried by a carrier fluid (settable or solidifiable) to bridge fractures induced in a wellbore wall. Optionally, a bridge sealing material may also be included in the wellbore for assisting in the sealing of the bridge. Such methods of treating and/or strengthening a wellbore may be applied in wellbore drilled with oil- or water-based fluids.

A fluid containing a carrier fluid and bridging materials may be introduced into the wellbore as a “pill” and may be squeezed into a low permeability formation at an increased pressure, in particular, at a pressure above the initial fracture pressure or re-open pressure of the formation. Thus, with the increased pressure, fractures are induced (or reopened) in the wellbore wall, and the bridging particulate material contained within the pill may bridge and seal the induced fractures at or near the mouth thereof. After strengthening the weak formation, the drilling assembly may be run back in the hole and drilling of the wellbore may be continued using a conventional drilling mud.

The bridging materials used to bridge fractures include those types of materials that are conventionally used in stress caging of high permeability formations. For example, bridging material that is carried by the carrier fluid to bridge the fractures may include at least one substantially crush resistant particulate solid such that the bridging material props open the fractures (cracks and fissures) that are induced in the wall of the wellbore. As used herein, “crush resistant” refers to a bridging material is physically strong enough to withstand the closure stresses exerted on the fracture bridge. Examples of bridging materials suitable for use in the present disclosure include graphite, calcium carbonate (preferably, marble), dolomite (MgCO₃.CaCO₃), celluloses, micas, proppant materials such as sands or ceramic particles and combinations thereof. Further, it is also envisaged that a portion of the bridging material may comprise drill cuttings having the desired average particle diameter in the range of 25 to 2000 microns.

The concentration of the bridging material may vary depending, for example, on the type of fluid used, and the wellbore/formation in which the bridging materials are used. However, the concentration should be at least great enough for the bridging material to rapidly bridge the fractures (i.e., cracks and fissures) that are induced in the wall of the wellbore but should not be so high as to make placement of the fluid impractical. Suitably, the concentration of bridging material in the drilling mud should be such that the bridging material enters and bridges the fracture before the fracture grows to a length that stresses are no longer concentrated near the borehole. This length is optimally on the order of one-half the wellbore radius but may, in other embodiments, be longer or shorter. In one embodiment, the concentration of bridging particles may be carried at an overly high concentration to ensure that appropriately sized particles do bridge and seal the fracture before the fracture grows in length well beyond the well. Thus, to ensure a sufficiently high concentration, in some embodiments, the concentration of bridging particles may be at least 5 pounds per barrel, at least 10 pounds per barrel, at least 15 pounds per barrel, and at least 30 pounds per barrel in various other embodiments. However, as discussed below, where the drilling mud is employed in a “pill” treatment, it may be desirable that concentration of the bridging particulate material be greater than 50 pounds per barrel in one embodiment, and greater than 80 pounds per barrel in another embodiment.

The sizing of the bridging material may also be selected based on size of the fractures predicted for a given formation. In one embodiment, the bridging material has an average particle diameter in the range of 50 to 1500 microns, and from 250 to 1000 microns in another embodiment. The bridging material may comprise substantially spherical particles; however, the bridging material may comprise elongate particles, for example, rods or fibers. Where the bridging material comprises elongate particles, the average length of the elongate particles should be such that the elongate particles are capable of bridging the induced fractures at or near the mouth thereof. Typically, elongate particles may have an average length in the range 25 to 2000 microns, preferably 50 to 1500 microns, more preferably 250 to 1000 microns. The bridging material is sized so as to readily form a bridge at or near the mouth of the induced fractures. Typically, the fractures that are induced in the wellbore wall have a fracture width at the mouth in the range 0.1 to 5 mm. However, the fracture width may be dependent, amongst other factors, upon the strength (stiffness) of the formation rock and the extent to which the pressure in the wellbore is increased to above initial fracture pressure of the formation during the fracture induction (in other words, the fracture width is dependent on the pressure difference between the drilling mud and the initial fracture pressure of the formation during the fracture induction step). In a particular embodiment, at least a portion of the bridging material, preferably, a major portion of the bridging material has a particle diameter approaching the width of the fracture mouth. Further, the bridging material may have a broad (polydisperse) particle size distribution; however, other distributions may alternatively be used.

In addition to bridging/propping open the fractures at their mouths, the bridge may also be sealed to prevent the loss of the bridge/material behind the bridge back into the wellbore. Depending on the material and/or particle size distribution selected as the bridging particles, and the material's sealing efficiency, it may be desirable to also include an optional bridge sealing material with the bridging material. However, one of ordinary skill in the art would appreciate that in some instances, a bridging material may possess both bridging and sealing characteristics, and thus, one additive may be both the bridging material and the bridge sealing material. Additionally, the use of a broad particle size distribution (and in particular, inclusion of fine bridging particles) may also be sufficient to seal the bridge formed at the mouth of the fracture. However, it may be desirable in other embodiments to also include a sealing material to further increase the strength of the seal. Additives that may be useful in increasing the sealing efficiency of the bridge may include such materials that are frequently used in loss circulation or fluid loss control applications. For example, such bridge sealing materials may include fine and/or deformable particles, such as industrial carbon, graphite, cellulose fibers, asphalt, etc. Moreover, one of ordinary skill in the art would appreciate that this list is not exhaustive, and that other sealing materials as known in the art may alternatively be used.

Examples of commercially available bridging additives or plugging agents include G-Seal®, G-Seal® Plus, and SafeCarb®, all provided by M-I LLC (Houston, Tex.). One of ordinary skill in the art will appreciate that other additives or agents may be used in different wellbore strengthening techniques, and that the procedures described in detail below may be used to determine the concentration and particle size distribution of proppant materials or other additives for such techniques.

The use of wellbore strengthening muds often requires “non-standard” drilling practices. Operators must load a circulating system with large solids and maintain the particle size distribution of the bridging and/or propping material with continuous additions of the bridging and/or propping material to the system while drilling. Wet sieve tests, in accordance with embodiments disclosed herein, may be performed at the rig site in order to maintain particle size distribution targets in the mud or wellbore fluid and to determine what size particles are needed in hourly maintenance of the fluid system.

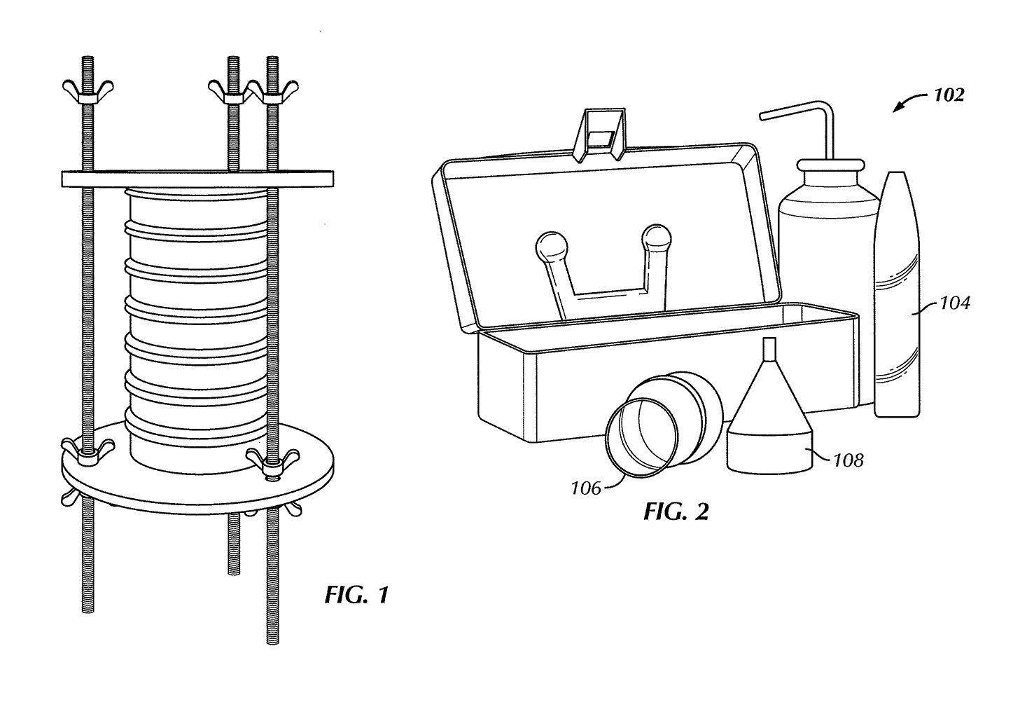

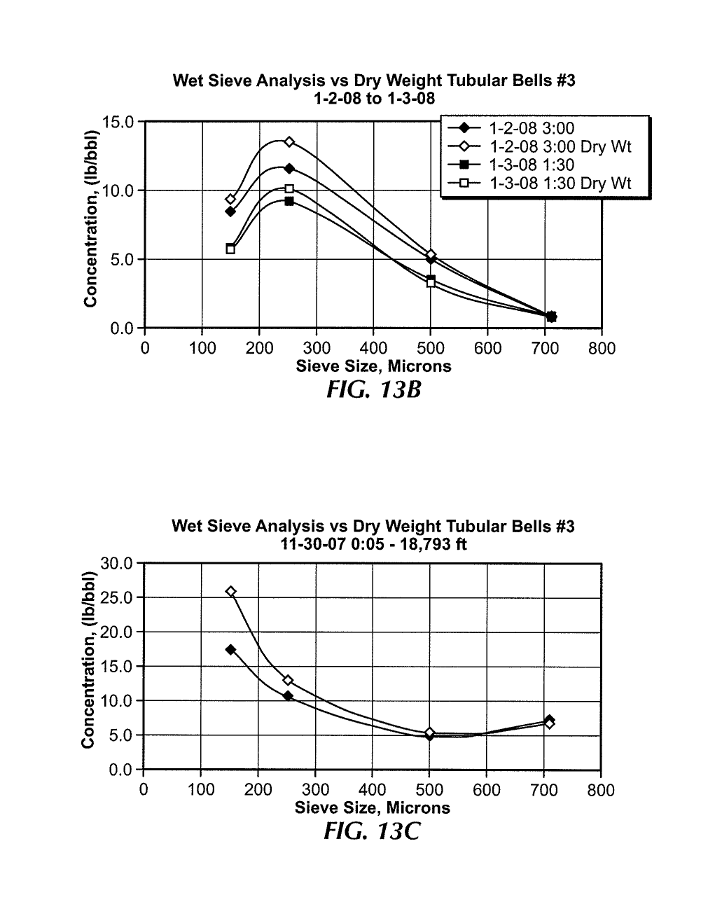

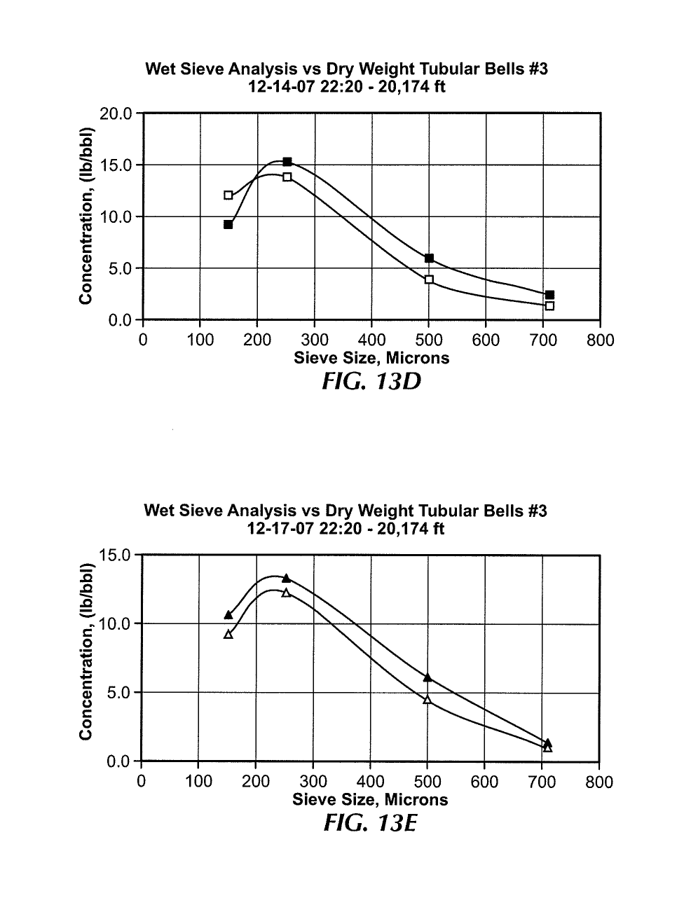

A rig-appropriate (non-electrical, portable) device, in accordance with embodiments disclosed herein, holds a stack (adjustable number of units) of sieves, as shown in FIG. 1, in order of larger to finer mesh, permitting a fluid sample (of known volume) to be passed through the sieves without bypass (i.e., without the fluid sample bypassing the screening material). Material retained on each sieve is recovered into a scribed tube that is then subjected to accelerated g-forces created by a hand-crank centrifuge. The volume of this compressed recovered material, divided by the initial fluid volume, expresses the bulk volume of sized material in the fluid (lower size boundary is defined by the sieve of interest and the upper size boundary by the sieve above). Empirically derived bulk density constants can be applied to calculate sized material concentrations in weight/volume units (such as lbs/bbl). Such constants can be confirmed by dry weighing of the retained material. See, for example, FIGS. 13A-13E.

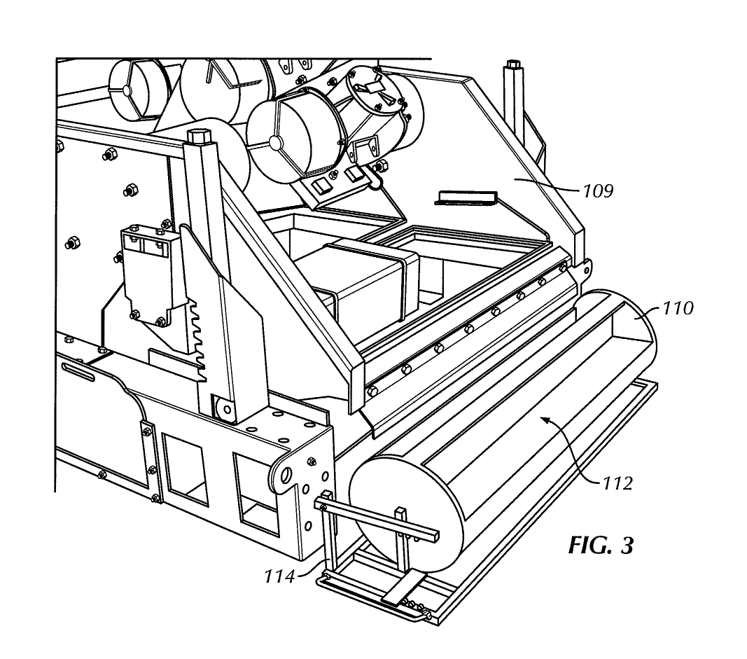

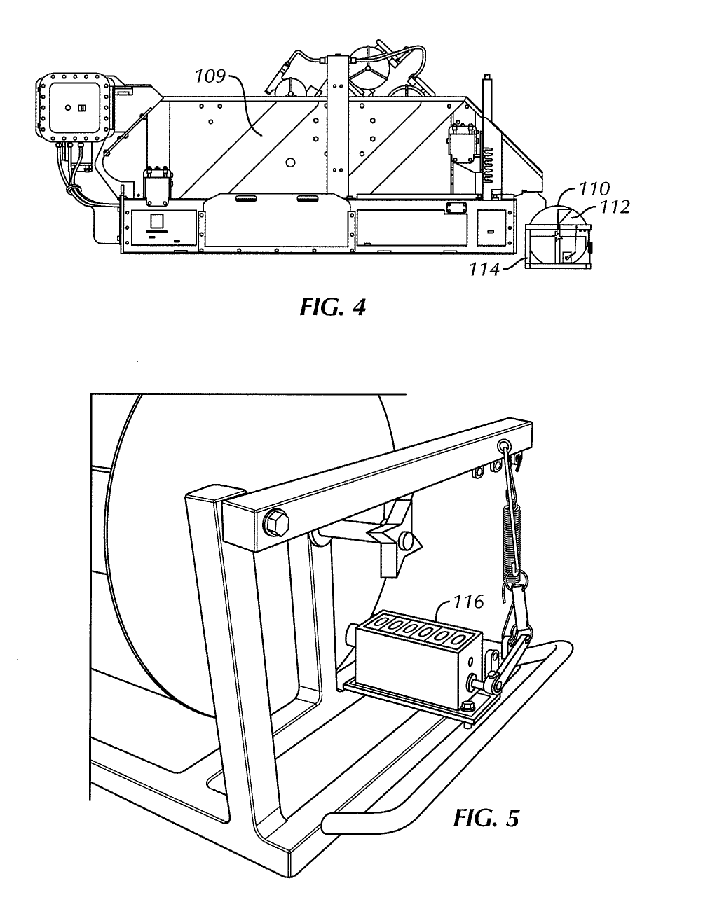

As shown in FIGS. 2-5, a wet-sieving system in accordance with embodiments disclosed herein includes a meter 110, a counter 116, a test kit 102, and a centrifuge (not shown). The wet-sieving system may be used to sample and test a mud once per hour while drilling with a managed particle size recovery (MPSR) unit. Additionally, the wet-sieving system may be used to sample and test mud in other applications, for example, when measuring hole cleaning efficiency in directional holes. In one embodiment, the meter 110 includes a receptacle 112 configured to receive separated material from a vibratory separator 109. The meter 110 is disposed at a discharge end of the vibratory separator 109 such that material on the recovery screen may fall off and into the receptacle 112 of the meter 110. In certain embodiments, the receptacle 112 has a cylindrical body and is mounted in a frame 114, wherein the cylindrical body is configured to rotate within the frame 114.

In one embodiment, the meter 110 may include a timing device (not shown). The timing device may include, for example, an automated timer or a simple stop watch. In this embodiment, the receptacle 112 of the meter 110 receives all material coming off of the recovery screen. A sample of separated material is collected in the receptacle 112 and the time it takes to fill the determined volume of sample is recorded. The separated material collected in the receptacle 112 is then transferred to a scribed container (not shown) and the volume of the separated material is visually estimated from the scribed lines and recorded.

In certain embodiments, the meter 110 may include a weighing device (not shown). In this embodiment, the weighing device senses the weight of the separated material transferred into the receptacle 112 of the meter 110 and rotates the receptacle 112 within the frame 114 to automatically transfer the separated material from the receptacle 112 to another container. For example, in one embodiment, the weighing device may include one or more adjustable springs. Thus, once the weight of the material in the receptacle 112 reaches a predetermined value, as set by the adjustable springs, the receptacle 112 rotates and transfers the separated material into a separate container.

Further, in certain embodiments, a counter 116 may be coupled to the meter 110 to count the number of times the receptacle 112 is filled. For example, in the embodiment described above wherein adjustable springs rotate the receptacle 112, when the receptacle 112 reaches a predetermined weight value, the counter 116 counts each time the receptacle rotates. Thus, based on the predetermined weight value and the number of receptacle 112 rotations recorded by the counter 116, the amount of separated material returned and recovered on the recovery screen may be determined. For example, if the spring is set at 20 lbs and the meter triggers the counter 10 times, then it is known that 200 lbs of separated material or product was returned.

A representative sample may then be obtained from the separated material collected in the container from the receptacle of the meter. The representative sample may be used to determine the particle size distribution of the wellbore fluid returned and to determine any necessary adjustments to the wellbore fluid for proper size distribution.

To determine the amount of bridging additives or plugging agents in the representative sample, a small test kit 102 and a centrifuge (not shown) are provided to an onsite mud engineer. The test kit 102, or sand content set, includes a sieve 106, a funnel 108 to fit the sieve 106, and two glass measuring tubes 104 marked with the volume of mud to be added and percent graduation marks to determine the amount of bridging additives or plugging agent in the mud. The centrifuge (not shown) may be, for example, a hand-crank centrifuge configured to receive both glass measuring tubes 104 from the test kit 102.

The procedure for determining the amount of bridging additives or plugging agents is now described with reference to determining the G-Seal® concentration by volume in a non-aqueous fluid. One of ordinary skill in the art will appreciate that the procedure outlined may also be used to determine the concentration of other bridging additives or plugging agents known in the art.

In this example, the test kit includes a 2½ inch diameter sieve with a 200 mesh screen (74 micron), a funnel to fit the sieve, and two glass measuring tubes including a mark for the volume of mud to be added, a mark for a clean base-oil addition, and percent graduation marks from 0 to 20%. The hand-crank centrifuge in this example is designed to receive the two glass measuring tubes from the test kit. One of ordinary skill in the art will appreciate that the number of sieves used and the size of the sieves (diameter and mesh size) may vary depending on, for example, the material being tested, the size of the sample, and the equipment available. The size of the sample being tested may also be varied. For example, in some embodiments a sample size of 100 mls, 200 mls, or 400 mls may be used.

To determine the concentration of G-Seal® in the wellbore fluid in this example, the first glass measuring tube is filled with mud to the indicated mark. Next, add clean base-oil to the measuring tube up to the next indicated mark. Cover the mouth of the tube and shake vigorously. Subsequently, pour and wash with base-oil, all of the mixture from the first measuring tube into a clean container, add to the container base-oil, of a volume four times that of the tubes. Subsequently, pour the mixture from the container onto the screen of the sieve and wash with base-oil. The material retained on the screen is then to be repeatedly washed with base-oil until the filtrate is clear.

Next, fit the funnel down over the top of the sieve and insert the tip of the funnel into the mouth of the glass tube. Any material retained on the screen may be washed into the tube by means of a fine spray of base-oil. Allow the material to settle in the measuring tube. The above steps are then repeated for the second measuring tube. Once both the first and second measuring tubes contain the same volume of fluid, place the tubes in the hand-crank centrifuge. For this example, spin the centrifuge for one minute at a one turn per second rate. One of ordinary skill in the art that the length of time and the rate of turns of the centrifuge may be varied without departing from the scope of embodiments disclosed herein.

Once centrifuging is complete, remove the measuring tubes from the centrifuge and estimate the percent by volume of G-Seal® in the measuring tube by observing the color of the material collected. Note that G-Seal® is black, while barite, sand, and other materials are a different color. If there are significant variations in the results of the amount of G-Seal® collected between the two measuring tubes, the test may be repeated.

Based on the volume percent of G-Seal® recorded in the above example, the pounds per barrel (ppb) G-Seal® may be determined by the following Equation:

Pounds per barrel (ppb) of material=Observed Volume Percent×3501bs×Bulk Density (1)

wherein the value 350 is the approximate weight of a barrel of water (42 gals×8.335 lbs/gal×SG of material, here SG of water is 1.0) and bulk density is the apparent density. For example, if the bulk density of the material is 1.1 and the observed volume of material was 7.5%, then Equation 1 provides that the pounds per barrel of material equals 0.075×350×1.1=28.9 lbs/bbl. Alternatively, the following simplified equation may be used:

Pounds per barrel of material=Observed Volume Percent×Bulk Density Conversion Factor (2)

wherein the bulk density conversion factor is determined by multiplying the weight of a barrel of water, 350 lbs, by the density of the material, and dividing by 100 to correct to decimal form. For example, a material with 0.9 SG bulk density, the conversion factor would be 3.2 ((350×0.9)/100). In this example, to determine the pounds per barrel of material, the volume percent is expressed as a whole number (e.g., 15.3% is expressed as 15.3, not 0.153) and multiplied by the bulk density conversion factor, 3.2. In this example, the material used was G-Seal®, but one of ordinary skill in the art will appreciate that the material may be any material known in the art as discussed above.

The procedure discussed above for determining G-Seal® concentration uses standard API sand content equipment, but adds acceleration of the material in the form of a hand-crank centrifuge to “compact” the material recovered by the screen before visually estimating volume on the marked or scribed measuring tubes.

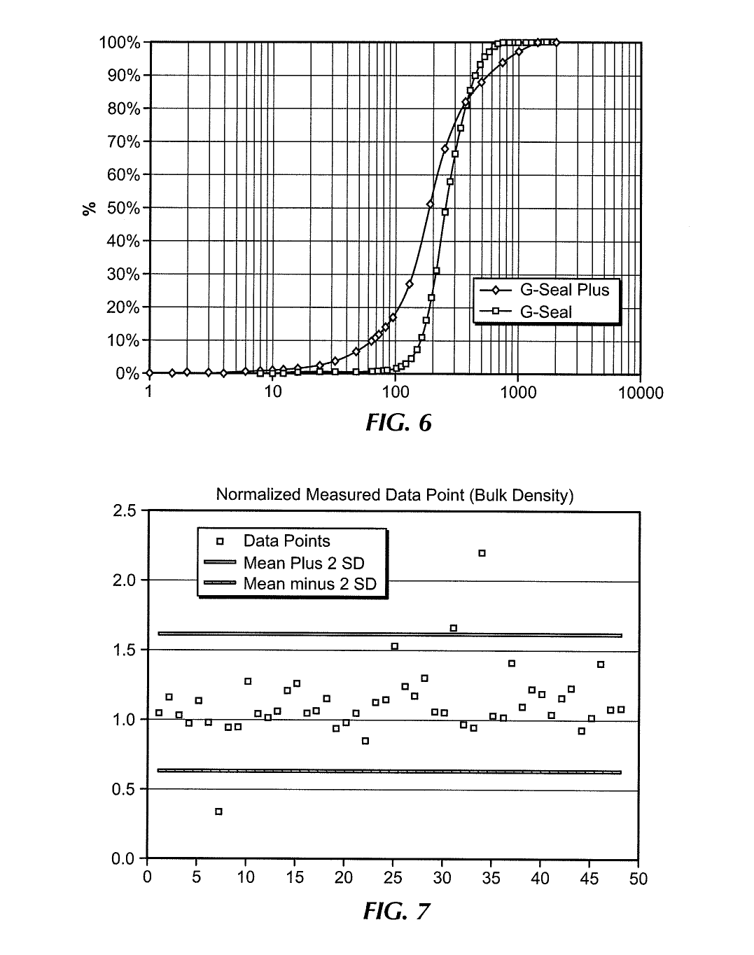

Referring to FIG. 6 illustrating a particle size distribution for G-Seal® and G-Seal® Plus, it is expected that roughly 12% G-Seal® Plus to be smaller than a standard 200 mesh (74 micron) san screen used to determine G-Seal® Plus concentration in the above outlined procedure. Therefore, if 10 ppb G-Seal® Plus was added to a clean mud pit, 8.8 ppb would be the expected material recovered, or 2.8% by volume using the procedure outlined above for determining G-Seal® Plus concentration.

A solid barrel of G-Seal® should weigh 700 lbs with a specific gravity of about 2.0. Thus, 2.8% by volume should therefore be equivalent to 19 ppb. However, the material recovered with a screen and collected in a measuring tube is not a solid mass, even after compacting the material with the hand-crank centrifuge. The bulk density factor corrects for the voids and synthetic fluids entrained in the material during the procedure described above. A barrel of material with a bulk density of 0.9 would weigh 315 lbs, and 2.8% by volume of this material would be equivalent to 8.8 ppb.

Thus, in the example above referring to FIG. 6, in which 10 ppb of G-Seal® Plus was added to a clean pit of mud, if a different percent by volume of material is obtained than expected and the particle size distribution information is correct, then the bulk density factor should be adjusted. For example, if the measured concentration of G-Seal® material is 2%, rather than the expected 2.8%, the new bulk density factor can be determined by:

New Bulk Density Factor=8.8 ppb/(0.02×350)=1.27 (3)

wherein it is known that 8.8 ppb of material was recovered by the test procedure for determining the concentration of G-Seal®.

Then, to adjust the factor used in the calculation provided the procedure outlined above for determining G-Seal® Plus concentration (i.e., 3.2 in Equation 1), Equation 4 may be used.

New Factor=(1.27×350)/100=4.4 (4)

Thus, substituting these new values in for Equation 1 provides:

Volume percent from measuring tube×New Factor=Expected G-Seal® recovered 2×4.4=8.8 ppb

Based on the procedures detailed above, the rate and quantity of G-Seal® recovery may then be determined using Equations 5 and 6 below.

Recovery Rate (lbs/hour)=C×V×85.7/T (5)

where C equals the pounds per barrel of G-Seal® determined by Equation 1, V equals the volume measured by the meter, and T equals the time (seconds) recorded by the timing device.

Quantity Recovered (lbs/hour)=Hours of MPSR operation×Recovery Rate (6)

In embodiments that include a stacked sieve analysis, or if a screen size other than the 200 mesh screen used in the procedures above is used, a particle size distribution graph, as shown in FIG. 6, may be used to determine how much freshly mixed product (i.e., bridging additive or plugging agent) should be collected in any particular screen bracket. For example, using the table below, a stacked sieve test employing a 100 micron over a 500 micron sieve on a mud with 20 ppb G-Seal® Plus added should collect approximately 13.8 ppb (7+4.2+2+0.6).

TABLE 1
Amount of Product Expected from a Stacked Sieve

| | | | Lbs of product |
|---|---|---|---|
| | | | collected on a |
| | | | brackted cut from |
| | | Amount of product | fresh additions of |
| | Amount of product | collected on a | 20 ppb G-Seal ® |
| Sieve | larger | bracketed cut (using | Plus (using this |
| Size | than the | this sieve size and | sieve size and the |
| (microns) | sieve size | the one above it) | one above it) |
| 74 | 88% | | |
| 100 | 82% | 6% | 1.2 |
| 200 | 47% | 35% | 7 |
| 300 | 26% | 21% | 4.2 |
| 400 | 16% | 10% | 2 |
| 500 | 13% | 3% | 0.6 |
| 600 | 10% | 3% | 0.6 |
| 700 | 8% | 2% | 0.4 |
| 800 | 5% | 3% | 0.6 |
| 900 | 2% | 3% | 0.6 |

Bulk Density Factor

During preliminary tests, the bulk density factor of G-Seal® particles was determined using the following analysis. First, 8 oz samples of mud were collected from a flow line (labeled S1), a shaker discharge before entering a dryer (labeled S2), a shaker under flow (labeled S3), a dryer discharge (labeled S4), a G-Seal® unit feed (labeled S5), and G-Seal(s) unit recovered G-Seal® (labeled S6). The samples were collected at Sep. 9, 2007 at 1800 hrs; Sep. 10, 2007 at 0600 hrs, 1200 hrs, and 1800 hrs; and Sep. 11, 2007 at 0000 hrs and 0600 hrs.

The samples were evaluated for solid percent content using a test kit, or sand content kit, as discussed above, which used a 200 mesh (75 microns) sized screen. Base-oil was used as the liquid medium in the test to dilute the mud once it was placed into the measuring tube. Each sample was first analyzed for solids percent volume content. This was done by placing either 25 ml or 50 ml of mud sample into the measuring tubes, then adding 75 ml or 50 ml of base-oil respectively. (A mud sample more than 25 ml would contain a large amount of G-Seal® and as such the G-Seal® would be very difficult to wash on the test kit's sieve and the 2-inch diameter sieves). The contents of the measuring tubes were then mixed by capping the tube and vigorously shaking it. The contents were then sieved through the test kit's screen, and thoroughly washed to rid all barite and clay. The retained solids were then washed back into the tube and placed into the hand-crank centrifuge. The centrifuge was balanced and was operated for one minute at a rate of one revolution per second. The volume of solid in the tube was noted.

Next, the solids were separated into three sizes; 75 to 250 microns, 250 to 500 microns and 500 plus microns, using three stacked sieves on top of a 32 oz container. The sieves had a diameter of 2 inches and one included a 500 micron screen, one included a 250 micron screen, and one included a 75 micron screen. The sieves were at a slight angle when resting on the container. The solids were then flushed onto the top (500 micron) sieve. Using a squirt bottle with base-oil, the solids were washed gently back and forth across the screen, while rotating the stacked sieves but keeping the container stationary. (Too much base-oil washing across the screens may back-up and overflow on all the sieves.)

When the top sieve was thoroughly washed until no more solids filtered through; the sieve was carefully picked up. The solids on that sieve were washed into a measuring tube by means of a funnel. Any solid particles that remained on the screen were removed by turning the sieve over onto the 2.5 inch diameter lid for the 32 oz container and knocking the lid with the sieve onto the table. Then removed solid, now on the lid, was washed into the measuring tube. The second sieve was similarly thoroughly washed until no solids filtered through. The sieve was carefully picked up and the solids on that sieve were washed into a measuring tube by means of a funnel.

The two tubes were placed in to the hand crank centrifuge and the centrifuge was operated for one minute at a rate of one revolution per second. The volume of solids in each tube was noted. The contents in each tube were washed back onto respective sieves. The solids on the last sieve (75 microns/200 mesh) were then washed into a measuring tube and placed into the centrifuge. The centrifuge was balanced and operated for one minute at a rate of one revolution per second. The volume of solid in the tube was noted. The solids were then washed back onto its sieve.

The sieves were stacked and placed on another 32 oz container. Using a squirt bottle with Arcosolv®, the solids were washed gently back and forth across the screen, while rotating the stacked sieves but keeping the container stationary. A 4-inch diameter filter paper was weighed and then folded to form a cone and was placed onto the mouth of another 32 oz container. The solids in the top sieve were then flushed (with Arcosolv®) onto the filter paper. The Arcosolv® drained through the paper leaving wet the sample. The paper was folded over so that sample would not fall out, and placed into a heating oven to at 130° F. to dry. Once dry, the sample and filter paper was weighed. The samples were set aside for future testing if needed.

Data collected from these tests and the calculated results are shown in the tables below. FIG. 7 shows the normalized bulk density data.

The calculations show an average bulk density factor of 1.1 with a standard deviation was 0.3. The mean plus 2 times the standard deviation is 1.6, and the mean minus 2 times the standard deviation is 0.6. This would show any data points out side this boundary as outliers and can be disregarded from use in the calculations. There were data points from sample S1/090907/1800 with particles in the range from 250-500 microns, and data points from sample S1/091007/1800 with particles in the range from 250-500 microns and 500 plus microns. Eliminating these data points gave a mean bulk density conversion factor of 3.85 based on 1.1 SG. A packing effect was noticed by the difference in the summation of the volumes of solids on the sieves, which was larger than the initial volume of solid mixed in the tube.

TABLE 2
Bulk Density Test Data

| | | | | | | | | Solids and filter | | | |
|---|---|---|---|---|---|---|---|---|---|---|---|
| | Solid % | | | | Filter paper, grms | | | paper, grms | | | Liquid |
| | | 75- | 250- | | 75- | 250- | | 75- | 250- | | Sample |
| Sample ID | >74 | 250μ | 500μ | 500μ+ | 250μ | 500μ | 500μ+ | 250μ | 500μ | 500μ+ | Size (ml) |
| S1/090907/1800 | 3 | 2.75 | 0.5 | 0.25 | | | | | | | 25 |
| S5/090907/1800 | 60 | 24 | 28.8 | 18.8 | | | | | | | 25 |
| S6/090907/1800 | 76 | 20 | 40 | 28 | | | | | | | 25 |
| S1/090907/1800 | 3.4 | 2.8 | 0.6 | 0.5 | 0.61 | 0.62 | 0.5 | 1.97 | 0.72 | 0.82 | 50 |
| S5/090907/1800 | 57.2 | 24 | 25 | 15 | 2.45 | 3.06 | 2.45 | 16.09 | 14.9 | 10.3 | 50 |
| S6/090907/1800 | 88 | 36 | 37 | 20 | 2.4 | 2.43 | 2.45 | 11.23 | 11.2 | 7.51 | 25 |
| S1/091007/0600 | 4 | 3.2 | 0.6 | 0.4 | 2.41 | 2.44 | 2.45 | 4.08 | 2.72 | 2.62 | 50 |
| S5/091007/0600 | 68 | 31 | 30 | 18 | 2.41 | 2.5 | 2.44 | 10.66 | 9.79 | 7.49 | 25 |
| S6/091007/0600 | 80 | 33.2 | 36 | 22 | 2.42 | 2.45 | 2.4 | 11.96 | 11.9 | 8.69 | 25 |
| S1/091007/1800 | 5 | 3.6 | 1 | 0.6 | 2.42 | 2.4 | 2.38 | 4.76 | 3.23 | 3.04 | 50 |
| S5/091007/1800 | 62 | 30 | 29 | 17 | 2.38 | 2.5 | 2.37 | 10.28 | 9.48 | 6.71 | 25 |
| S6/091007/1800 | 70 | 32 | 32 | 18 | 2.51 | 2.4 | 2.4 | 10.9 | 9.91 | 6.96 | 25 |
| S1/091107/0600 | 4.4 | 3.6 | 0.9 | 0.6 | 2.39 | 2.39 | 2.38 | 4.52 | 2.94 | 2.8 | 50 |
| S5/091107/0600 | 72 | 31 | 32 | 16 | 2.39 | 2.38 | 2.4 | 10.36 | 9.72 | 6.69 | 25 |
| S6/091107/0600 | 76 | 32 | 36 | 18 | 2.39 | 2.4 | 2.38 | 11.6 | 11.5 | 7.22 | 25 |

TABLE 3
Calculated Results for Bulk Density Test Data

| | Solid % | | | | | Solids, grms | | | | | Liquid |
|---|---|---|---|---|---|---|---|---|---|---|---|
| | | 75- | 250- | | | | 75- | 250- | | | Sample |
| Sample ID | >74 | 250μ | 500μ | 500μ+ | Sum | >74 | 250μ | 500μ | 500μ+ | Sum | Size (ml) |
| S1/090907/1800 | 3 | 2.75 | 0.5 | 0.25 | 3.5 | | | | | | 25 |
| S5/090907/1800 | 60 | 24 | 28.8 | 18.8 | 71.6 | | | | | | 25 |
| S6/090907/1800 | 76 | 20 | 40 | 28 | 88 | | | | | | 25 |
| S1/090907/1800 | 3.4 | 2.8 | 0.6 | 0.5 | 3.9 | | 1.36 | 0.1 | 0.32 | 1.78 | 50 |
| S5/090907/1800 | 57.2 | 24 | 25 | 15 | 64 | | 13.64 | 11.8 | 7.83 | 33.27 | 50 |
| S6/090907/1800 | 88 | 36 | 37 | 20 | 93 | | 8.83 | 8.76 | 5.06 | 22.65 | 25 |
| S1/091007/0600 | 4 | 3.2 | 0.6 | 0.4 | 4.2 | | 1.67 | 0.28 | 0.17 | 2.12 | 50 |
| S5/091007/0600 | 68 | 31 | 30 | 18 | 79 | | 8.25 | 7.29 | 5.05 | 20.59 | 25 |
| S6/091007/0600 | 80 | 33.2 | 36 | 22 | 91.2 | | 9.54 | 9.42 | 6.29 | 25.25 | 25 |
| S1/091007/1800 | 5 | 3.6 | 1 | 0.6 | 5.2 | | 2.34 | 0.83 | 0.66 | 3.83 | 50 |
| S5/091007/1800 | 62 | 30 | 29 | 17 | 76 | | 7.9 | 6.98 | 4.34 | 19.22 | 25 |
| S6/091007/1800 | 70 | 32 | 32 | 18 | 82 | | 8.39 | 7.51 | 4.56 | 20.46 | 25 |
| S1/091107/0600 | 4.4 | 3.6 | 0.9 | 0.6 | 5.1 | | 2.13 | 0.55 | 0.42 | 3.1 | 50 |
| S5/091107/0600 | 72 | 31 | 32 | 16 | 79 | | 7.97 | 7.34 | 4.29 | 19.6 | 25 |
| S6/091107/0600 | 76 | 32 | 36 | 18 | 86 | | 9.21 | 9.07 | 4.84 | 23.12 | 25 |

| | Concentration (ppb) | | | | | Bulk Density Factor | | | | |
|---|---|---|---|---|---|---|---|---|---|---|
| | | 75- | 250- | | | | 75- | 250- | | |
| Sample ID | >74 | 250μ | 500μ | 500μ+ | Sum | >74 | 250μ | 500μ | 500μ+ | Sum |
| S1/090907/1800 | 12 | 10 | 1 | 2 | 12 | 1.0 | 1.0 | 0.3 | 1.3 | 0.9 |
| S5/090907/1800 | 233 | 95 | 83 | 55 | 233 | 1.2 | 1.1 | 0.9 | 1.0 | 1.0 |
| S6/090907/1800 | 317 | 124 | 123 | 71 | 317 | 1.0 | 1.0 | 0.9 | 1.0 | 1.0 |
| S1/091007/0600 | 15 | 12 | 2 | 1 | 15 | 1.1 | 1.0 | 0.9 | 0.9 | 1.0 |
| S5/091007/0600 | 288 | 116 | 102 | 71 | 288 | 1.2 | 1.1 | 1.0 | 1.1 | 1.0 |
| S6/091007/0600 | 354 | 134 | 132 | 88 | 354 | 1.3 | 1.1 | 1.0 | 1.1 | 1.1 |
| S1/091007/1800 | 27 | 16 | 6 | 5 | 27 | 1.5 | 1.3 | 1.7 | 2.2 | 1.5 |
| S5/091007/1800 | 269 | 111 | 98 | 61 | 269 | 1.2 | 1.1 | 1.0 | 1.0 | 1.0 |
| S6/091007/1800 | 286 | 117 | 105 | 64 | 286 | 1.2 | 1.0 | 0.9 | 1.0 | 1.0 |
| S1/091107/0600 | 22 | 15 | 4 | 3 | 22 | 1.4 | 1.2 | 1.2 | 1.4 | 1.2 |
| S5/091107/0600 | 274 | 112 | 103 | 60 | 274 | 1.1 | 1.0 | 0.9 | 1.1 | 1.0 |
| S6/091107/0600 | 324 | 129 | 127 | 68 | 324 | 1.2 | 1.2 | 1.0 | 1.1 | 1.1 |

TABLE 4
Calculated Conversion Factors

| | Bulk Density Conversion Factor | | | | |
|---|---|---|---|---|---|
| Sample ID | >74 | 75-250μ | 250-500μ | 500μ+ | Sum |
| S1/090907/1800 | 3.7 | 3.4 | 1.2 | 4.5 | 3.2 |
| S5/090907/1800 | 4.1 | 4.0 | 3.3 | 3.7 | 3.6 |
| S6/090907/1800 | 3.6 | 3.4 | 3.3 | 3.5 | 3.4 |
| S1/091007/0600 | 3.7 | 3.7 | 3.3 | 3.0 | 3.5 |
| S5/091007/0600 | 4.2 | 3.7 | 3.4 | 3.9 | 3.6 |
| S6/091007/0600 | 4.4 | 4.0 | 3.7 | 4.0 | 3.9 |
| S1/091007/1800 | 5.4 | 4.6 | 5.8 | 7.7 | 5.2 |
| S5/091007/1800 | 4.3 | 3.7 | 3.4 | 3.6 | 3.5 |
| S6/091007/1800 | 4.1 | 3.7 | 3.3 | 3.5 | 3.5 |
| S1/091107/0600 | 4.9 | 4.1 | 4.3 | 4.9 | 4.3 |
| S5/091107/0600 | 3.8 | 3.6 | 3.2 | 3.8 | 3.5 |
| S6/091107/0600 | 4.3 | 4.0 | 3.5 | 3.8 | 3.8 |

The samples were a combination of drill cuttings and G-Seal® Plus with similar sized particles. Thus each sample contained a portion of drill cuttings that occupied both volume and weight. It was estimated by visual inspection that about 25%, 30% and 80% of the sample for samples 75 to 250 microns, 250 to 500 microns, and 500 plus microns were drill cuttings. Further testing by X-Ray diffraction should show the true amount of drill cuttings and G-Seal® in the samples. With the true volume of G-Seal® in the samples known, then the correct weight can then be calculated from the volume by use of its density, bulk and sized for 75 to 250 microns, 250 to 500 microns, and 500 plus microns.

### Example 1

### Portable Wet-Sieving Device Test

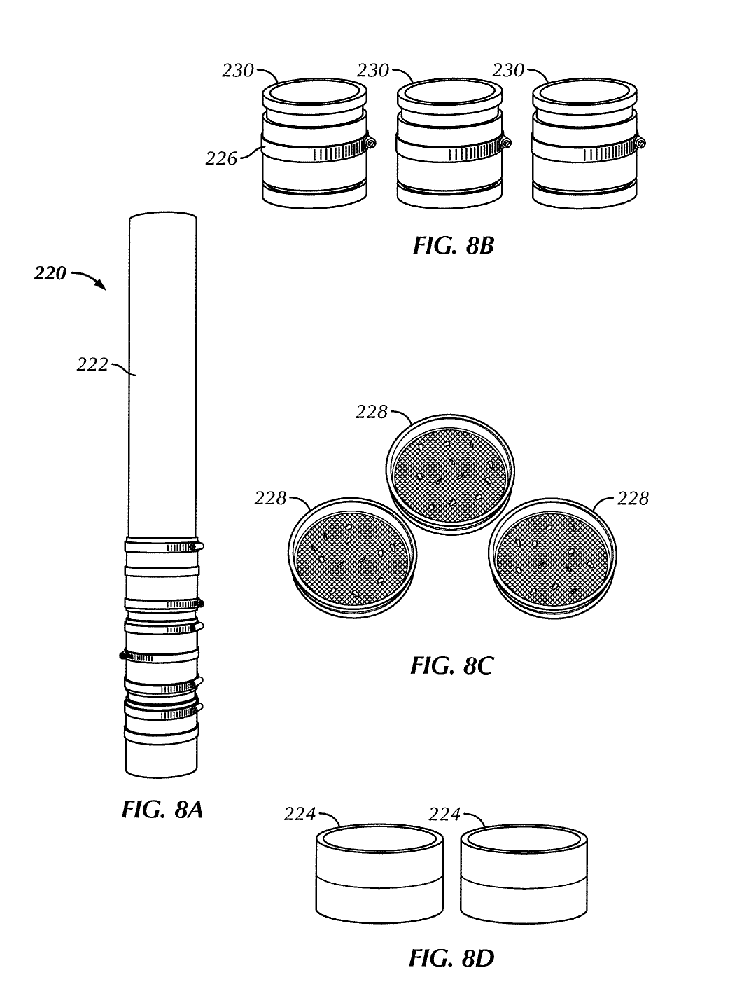

An example of a portable wet-sieving device in accordance with embodiments disclosed herein is now described. As shown in FIGS. 8A-8D, the portable wet-sieving device 220 includes a section of PVC-DWV 222, schedule 40, with a 3 inch inner diameter, 3 7/16 inch outer diameter, and approximately 1.5 feet long, three flexible rubber couplings 230 with 3⅜ inch inner diameters, two PVC-DWV schedule 40 couplings 224 with 3 inch inner diameters, 3 7/16 inch outer diameter, and approximately 2 inches long, eight 3-inch hose clamps 226, and three sieves 228 with 3 inch inner diameters, 3¼ inch outer diameter.

To assemble the portable wet-sieving device 220, place a hose-clamp 226 on the outside of one of the couplings 230, and insert a sieve 228 into one of the flexible rubber couplings, both about 1.5″ from the top of the coupling. Tighten the clamp 226 until it is snug, allowing for a good seal around the sieve 228. Repeat these steps with the other sieves 228. Next, take the rubber coupling with the largest mesh sieve (smallest micron size), and insert a 2″ long PVC coupling 224, 1″ into the top of the rubber coupling 230. Place the PVC coupling 224 onto the top of the rubber coupling 230 and twist and push down the PVC into the rubber coupling. Pealing back the lip of the rubber coupling helps with the insertion of the PVC. Do not insert the PVC more than 1″ into the rubber coupling. Place a hose-clamp 226 on the outside and top of the rubber coupling 230. Tighten the clamp 226 until it is snug, holding the PVC in the rubber coupling 230. Take the rubber coupling 230 with the second largest mesh sieve 228 (the second smaller micron size), and invert it. Taking the assembled rubber coupling 230, that has the PVC attached to it, insert the PVC 1″ into the bottom of the rubber coupling 230 that has the second largest mesh sieve 228. Do not insert the PVC more than 1″ into the rubber coupling. Place a hose-clamp 226 on the outside and bottom of the rubber coupling 230 that has the second largest mesh sieve 228. Tighten the clamp 226 until it is snug, holding the PVC in the rubber coupling 230. Take the assembled rubber couplings and set them right side up. Insert a 2″ long PVC coupling 224 1″ into the top of the rubber couplings 230. Do not insert the PVC more than 1″ into the rubber coupling. Place a hose-clamp 226 on the outside and top of the rubber coupling 230. Tighten the clamp 226 until it is snug, holding the PVC in the rubber coupling. Take the rubber coupling 230 with the smallest mesh sieve 228 (the largest micron size), and invert it. Taking the assembled rubber couplings 230 that has the PVC attached to it, insert the PVC 1″ into the bottom of the rubber coupling 230 that has the smallest mesh sieve 228. Do not insert the PVC more than 1″ into the rubber coupling. Place a hose-clamp 226 on the outside and bottom of the rubber coupling 230 that has the smallest mesh sieve 228. Tighten the clamp until it is snug, holding the PVC in the rubber coupling 230. Take the assembled rubber couplings 230 and set them right side up. Insert the 1.5° long PVC into the top of the rubber couplings 230. Do not insert the PVC more than 1″ into the rubber coupling. Place a hose-clamp 226 on the outside and top of the rubber coupling 230. Tighten the clamp until it is snug, holding the PVC in the rubber coupling 230.

Once the portable wet-sieving device 220 is assembled, input a mud sample with solids into the top of the device and flush it with a base fluid of the mud. Do not flood the device with fluid such that it over flows from the top. Do not wash the outside of the device with base fluid, so as to avoid lubricating and loosening the hose during vibration of the device. Ensure that all of the clamps are tightened snuggly, but not over tightened as such to cut into the rubber.

The portable wet-sieving device 220 may be shaken or vibrated, but splashing of any of the mud out of the top of the device should be avoided. Place a cap to cover the top of the device if extreme shaking is needed. Ensure that any solids stuck on the cap after shaking are washed back into the device. If the screens of the sieves in the device are blinded or clogged from the mud sample, gently tap the side of the device, at the rubber couplings, with a rubber mallet. Do not hit any part of the device with sharp, or metal, or hard objects; as doing such could cause the hose clamps to be loosened or damaged.

The rubber part of the device may gently touch a shaker to aid in vibrating the mud through the device. Touch the device to a shaker in a safe location of the shaker, so as to avoid damage to the shaker, injury to personnel in the local vicinity, and damage to the device itself.

The portable wet-sieving device 220 was tested to ensure the design of the seal provides a seal around the sieves and prevents fluids and particles from bypassing the screen. In this test, the portable wet-sieving device 220 included three sieves, one having a 500 micron screen, one having a 250 micron screen, and one having a 106 micron screen.

First, G-Seal® was sifted dry through three stacked sieves. The screen sizes of the sieves were 600, 300, and 180 microns. The sieves were stacked with the 600 on top, 300 in the middle and 180 on the bottom.

The portable wet-sieving device was then set with one sieve of size 500 microns. Two grams of G-Seal® sized at 600 microns were poured into the device. Then two gallons of water were flushed through the device and all of the water was collected into a two gallon container. The collected water in the container was then visually observed to see if any G-Seal® had been flushed in to it. If there was any G-Seal®, then it would mean that there was a leak or bypass in the device. The above procedure was repeated with 250 and 106 micron sieves, using 300 and 180 micron sized particles of G-Seal, respectively.

The portable wet-sieving device 220 was set with three stacked sieves of size 106 microns on top, then 250 microns in the middle, and 500 microns on bottom. A sample of six grams of G-Seal®, with two grams each of particles 600, 300, and 180 microns, was made. The sample was then poured into the device 220. Then two gallons of water were flushed through the device 220, and all of the water was collected into a two gallon container. The collected water in the container was then visually observed to see if any G-Seal® had been flushed in to it. If there was any G-Seal® present in the collected water, then it would mean that there was a leak or bypass in the device 220. The device 220 was then carefully disassembled and each sieve was visually observed. In this test, all the G-Seal® was caught on the top sieve. No G-Seal® was seen in the container. These two observations lead to the conclusion that there was no bypass around the sieves in the device.

An additional test was then performed wherein the portable wet-sieving device 220 was set with three stacked sieves of size 500 microns on top, then 250 microns in the middle, and 106 microns on bottom. A sample of six grams of G-Seal®, with two grams each of particles 600, 300, and 180 microns, was made. The sample was then poured into the device. Then two gallons of water were flushed through the device, and all off the water was collected into a two gallon container. The collected water in the container was then visually observed to see if any G-Seal® had been flushed in to it. If there was any G-Seal® present in the collected water, then it would mean that there was a leak or a bypass in the device 220. The device 220 was then carefully disassembled and each sieve was visually observed. G-Seal was caught on each sieve with the appropriate sized particles. Further, no G-Seal® was in the container. Therefore, there was no leak or bypass around the sieves 228 in the device 220.

To disassemble the portable wet-sieving device 220, first rest the device on a stable surface. Loosen the top hose clamp 226 on the top rubber coupling 230. Separate the rubber couplings 230 from the 1.5 foot long PVC section 222. If solids remain on the lip of the PVC section, use a squirt bottle to flush the solid onto the top sieve 228.

Next, loosen the top hose clamp 226 on the middle rubber coupling 230. Separate the middle rubber coupling 230 from the PVC section 222. If solids remain on the lip of the PVC section, use a squirt bottle to flush the solid onto the middle sieve 228. Solid may also be on the area of the rubber coupling that is between the PVC and the sieve. Using a squirt bottle, flush the solid onto the middle sieve 228. Be careful not to wash away any solids that have been caught on the top sieve 228. Flush solids on the top sieve 228 into a clean container. Repeat the previous steps for disassembling one rubber coupling at a time, with the next rubber couplings 230. After the sieved solids have been extracted from the device 220, clean the device with soap and water. Dry the parts and then reassemble the portable wet-sieving device 220.

The results of these tests are summarized in the tables below.

TABLE 5
Portable Wet-Sieving Device with Individual Sieves

| Sieve Size | Particle Size Used | Observations |
|---|---|---|
| 500μ | 300μ | No G-Seal ® in container |
| 250μ | 300μ | No G-Seal ® in container |
| 106μ | 180μ | No G-Seal ® in container |

TABLE 6
Portable Wet-Sieving Device with Stacked Sieves

| Sieves Size | Observations |
|---|---|
| 106μ | All G-Seal ® on sieve, No G-Seal ® in container |
| 250μ | No G-Seal ® on sieve, No G-Seal ® in container |
| 500μ | No G-Seal ® on sieve, No G-Seal ® in container |

TABLE 7
Portable Wet-Sieving Device with Stacked Sieves

| Sieves Size | Observations |
|---|---|
| 500μ | G-Seal (600μ) on Sieve, No G-Seal in bucket |
| 250μ | G-Seal (300μ) on Sieve, No G-Seal in bucket |
| 106μ | G-Seal (180μ) on Sieve, No G-Seal in bucket |

The observations of no bypass of G-Seal® being found lead to the conclusion that the portable wet-sieving device seals well around the sieves that are within it, and that the device is acceptable to be used for sieving.

### Example 2

### Portable Wet-Sieving Device

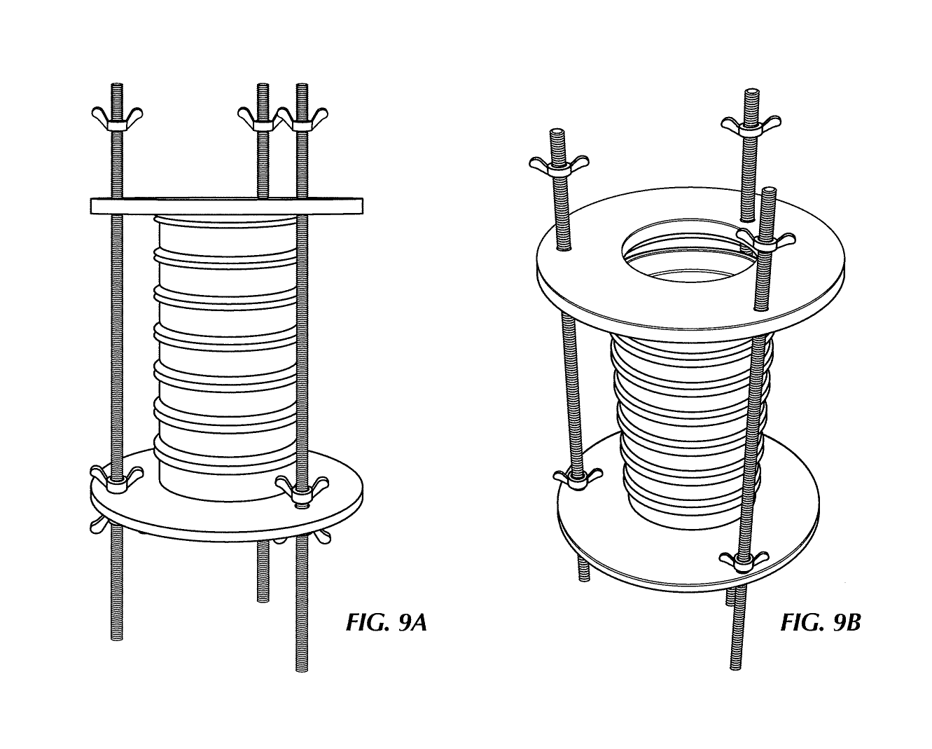

Another example of a portable wet-sieving device in accordance with embodiments disclosed herein is now described. As shown in FIGS. 9A and 9B, the wet-sieving device includes two flat steel plates, three ¼ inch threaded steel rods that are 1 foot long, nine wing nuts that fit the ¼ inch threaded rods, 3-inch sieves, and o-rings that tightly fit the sieves. The two flat steel plates are ¼ inch thick, have a 6-inch outer diameter, 2.5 inches inner diameter cut out, and three ¼ inch holes are drilled ½ inch from the outer edge of the plates, wherein the holes are spaces at 120 degrees from each other.

To assemble the wet-sieve device of FIGS. 9A and 9B, the threaded rods are inserted two inches into one plate through the ¼ inch holes. Wing nuts, two for each rod, are treaded onto the rods from both sides of the plate and secured tightly. The apparatus at this point needs to be stood horizontally on the ends of three rods that are closest to the plate. The wing nut holding the plate should then be used to adjust the plate to be horizontal. Using two wing nuts on each rod, on opposite sides of the plate helps keep the rods perpendicular to the plate. Each sieve would be fitted with an O-ring to create a seal between two interlocking sieves. Stack the sieves one on the other with the smallest micron sized sieve to the largest micron size sieve. The stack of sieves would then be places on the center of the plate. Then second plate (the top plate) would then be feed through the rods, and lowered onto the top of the stack of sieves. Three wing nuts, one for each rod, would then be threaded from the top of the rods down onto the top plate. Tighten down the top plate onto the stack of sieves, while yet keeping the top plate horizontal. Be care full not to tighten too much. If the o-rings are not the correct thickness, too big and it will bulge out from between the sieves, too small and will not form a seal. To remove the sieves, loosen the wing nuts above the top plate and slide the stack of sieves out sideways.

### Example 3

### Portable Wet-Sieving Device

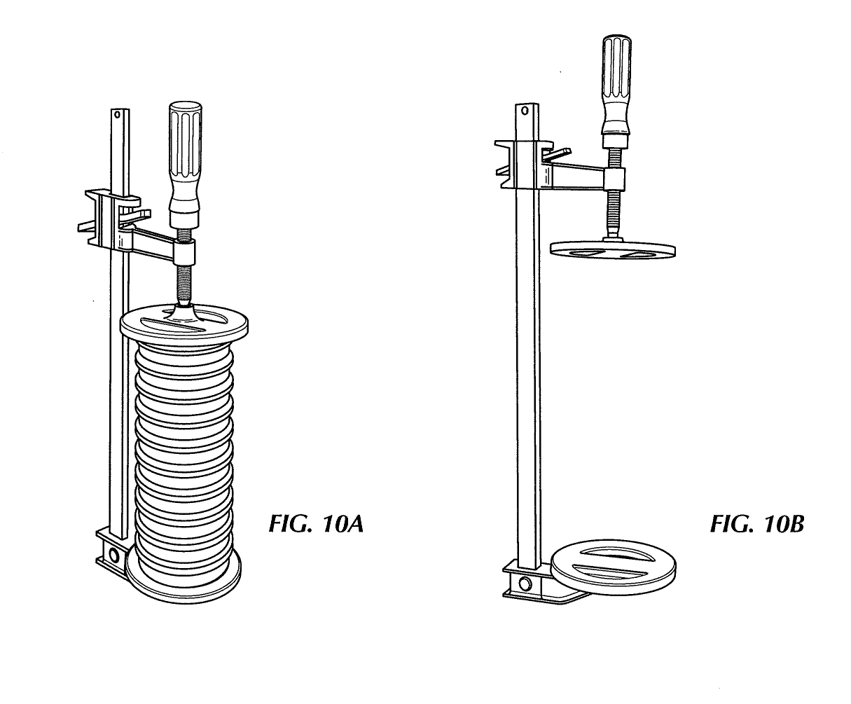

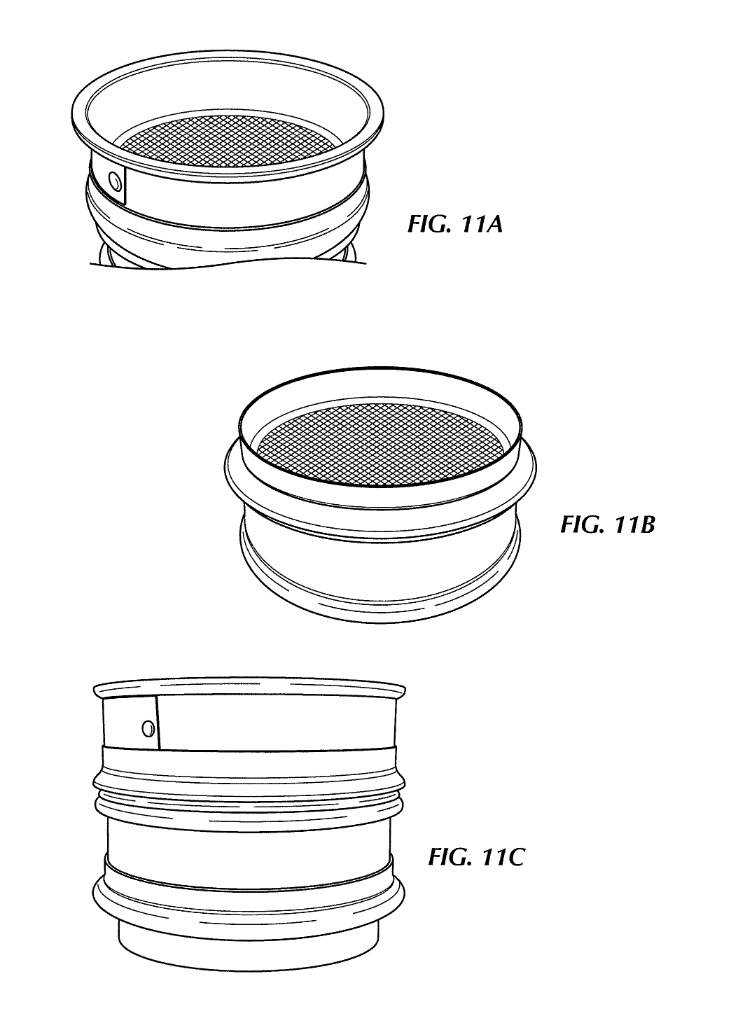

Another example of a portable wet-sieving device in accordance with embodiments disclosed herein is now described. As shown in FIGS. 10A and 10B, the wet-sieving device includes two flat steel plates, one C-clamp 3.5 inches by one foot ¼ inch thick, 3-inch sieves, and o-rings that tightly fit the sieves. In this example, the two flat steel plates have 3.5-inch outer diameters, 2.75 inches inner diameter cut out, except for a strip 0.5 inches wide in the middle of the plate.

To assemble the wet-sieve device of FIGS. 10A and 10B, weld the center of the clamps face, while keeping the plates horizontal, running parallel to each other. Open the clamp and insert a stack of sieves. Each sieve would be fitted with an O-ring to create a seal between two interlocking sieves. Stack the sieves one on the other with the smallest micron sized sieve to the largest micron size sieve. The stack of sieves would then be places on the center of the plates. Tighten down the clamp onto the stack of sieves. Be care full not to tighten too much. If the O-rings are not the correct thickness, too big and it will bulge out from between the sieves, too small and will not form a seal. To remove the sieves, loosen the clamp and slide the stack of sieves out sideways

If a sieve larger than 3 inches is needed then the plate may be made to fit said size. In one embodiment, the sieves may include a flat lip on a female end (FIG. 11A) and a concave contour on the top of the male end where it joins the body of the sieve (FIG. 11B). This type of the sieve may be designed to hold an o-ring to provide a seal (FIG. 11C).

Method of Determining Concentration and Total Amount by Weight of Loss Prevention Material (LPM)

A method of determining the pound per barrel (lb/bbl) concentration of LPM-sized materials in drilling fluid samples taken from the discharge end of a MPSR unit, in accordance with embodiments disclosed herein, using a sand content or test kit wet-sieve onsite method, to determine the volume concentration of LPM in said sample is now discussed. Additionally, a method of determining the total amount by weight of LPM returned to the active system is discussed. As discussed below, this is done by calculating the total volume of mud with LPM returned from the MPSR unit.

Equipment for performing the method of determining concentration and total amount by weight of LPM may include mud system samples, base oil/fluid, squirt bottles, funnels, sand content or test kit, hand crank centrifuge, two 100 ml solid-content tubes for the centrifuge, rack to hold 100 ml solid content tubes, meter, mud scale, timer (e.g., stop watch).

Every 24 hour period record the volume of wet-LPM discharged by the MPSR unit. If continuously feeding the MPSR unit with fluid to be processed and if a meter, as discussed in detail above, is being used, collect a sample of the wet-LPM from the unit's discharge per 12 hr-towers at equally spaced intervals. Record the counter value on the counter coupled to the meter, and then reset the counter.

If continuously feeding the MPSR unit with fluid to be processed and a collection tray is being used, collect samples of the wet-LPM from the unit's discharge per 12 hr-towers at equally spaced intervals. When a sample is taken, use the receptacle to measure the volume of wet-LPM being discharged from the shaker, by timing how long the receptacle fills and for how long the unit is being fed the batch of fluid. Also record how long the shaker is being fed fluid for that day.

If feeding the unit in batches of fluid, and the meter is being used, collect a sample of the wet-LPM from the unit's discharge per 12 hr-towers for each batch being processed. Record the counter value on the counter coupled to the meter, and then reset the counter.

If feeding the unit in batches of fluid, and a collection receptacle is being used, collect a sample of the wet-LPM from the unit's discharge per 12 hr-towers for each batch being processed. Also for each batch, use the receptacle to measure the volume of wet-LPM being discharged from the shaker, by timing how long the receptacle fills and for how long the unit is being feed the batch of fluid.

In certain embodiments, it may be beneficial to collect and testing at least 4 of these samples if time permits. The collected samples will be tested for density and concentration of LPM being discharged by the MPSR unit.

Collect a large enough sample of the MPSR unit discharge to do the following tests. Determine the density of the sample, one way to do this is by using a mud scale. Determine the solids volume %, by using a sand content or test kit. The sand content kit should include at least one screen, for example, a 200 mesh, microns screen. Fill a clean hand crank centrifuge glass tube to the recommended mark of 100 ml with wet-LPM fluid sample, if 100 ml is too great of a sample to use, a lower volume may be used, such as 50 ml or 25 ml. Pour the entire contents of this glass tube into a clean bucket. Using base oil/fluid of the mud system, wash the mud residue, in the tube, into the bucket. Add 400 ml of base oil/fluid to the bucket. Agitate the contents of the bucket with a stirring rod. Flush the bucket's contents over the sieve. Wash the bucket with base oil/fluid onto the sieve.

Using base oil, flush the screen until the underflow is clear of suspended sediment or other indications of screen carry-through. Carefully and without spilling any of the solid material collected on the screen, wash the material into a clean hand crank centrifuge 100 ml glass tube. Use a squirt bottle of base oil/fluid to flush the screen, and a funnel to direct the material into the glass tube. Fill another tube to the same height with base oil/fluid.

Load the hand-crank centrifuge with the two tubes and centrifuge for one minute. It may be beneficial to allow 5 seconds for the centrifuge to come up to a speed of one rotation per second, then hold that speed for the next 60 seconds. Remove the tubes from the apparatus and record the apparent volume of solid material in mls for the tube.

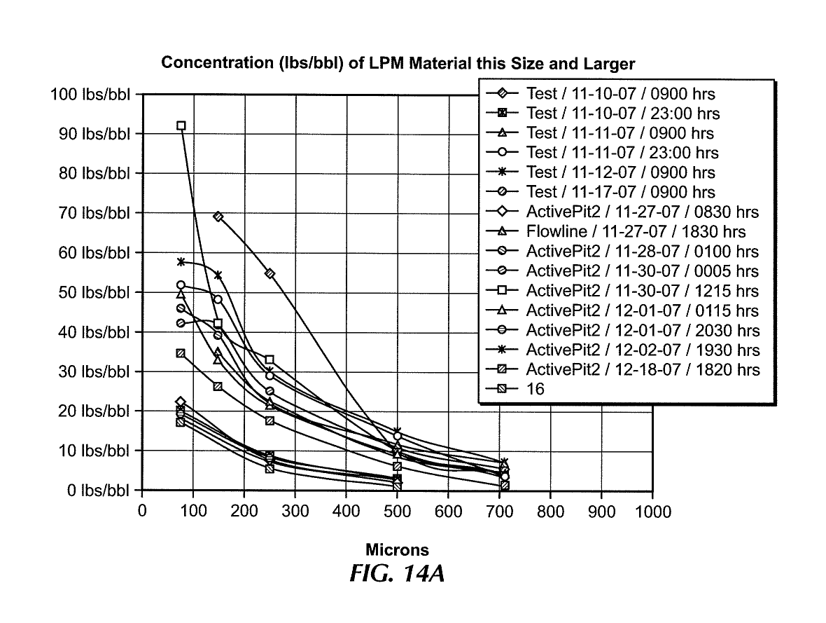

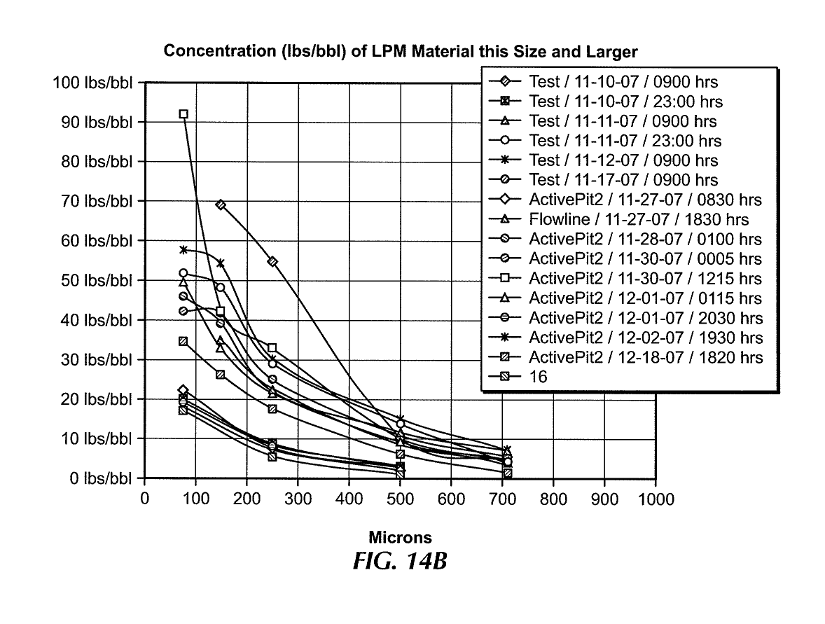

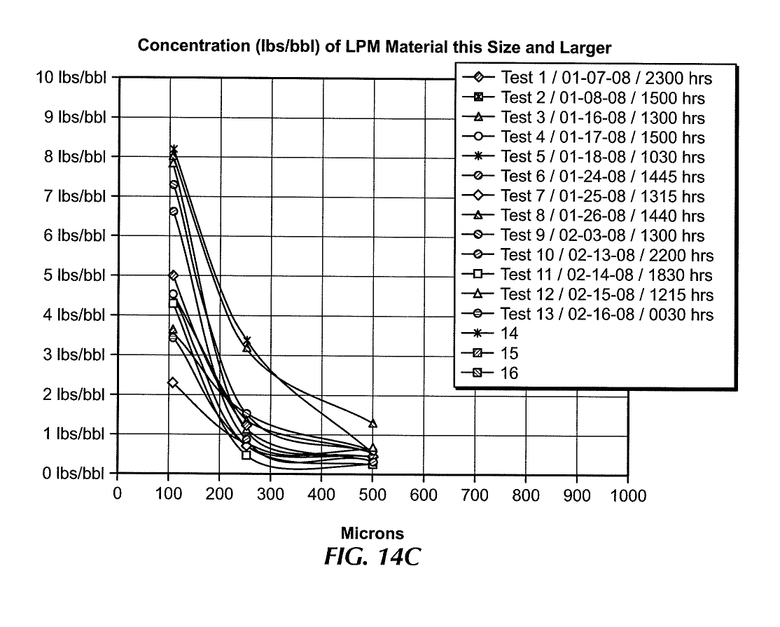

Results from the wet-sieving analysis showing the determined concentration of LPM material is summarized in FIGS. 14A-14C.

Method of Determining Concentration, Size Distribution, and Amount by Weight to Volume Ratio of LPM in Fluid

A method of measuring the particle size distribution and the pound per barrel (lb/bbl) concentration of LPM-sized materials in drilling fluid samples taken from the suction pit (this represents what is being sent down hole) using a stacked-wet-sieve onsite method in accordance with embodiments disclosed herein is now described. This may be validated by further analysis (dried weight, XRD and Coulter PSD) of split samples sent to a lab is also described.

Equipment for performing the method of determining concentration, size distribution, and amount by weight to volume ratio of LPM in a fluid may include mud system samples, base oil (IO C 16/18), three 3″ sieves, 1-500 micron screen, 1-250 micron screen, 1-106 micron screen, 32 oz containers with lids and labels, containers with lids and labels, squirt bottles, collection receptacles, a rubber mallet, funnels, wet-sieving device, hand crank centrifuge, two 100-ml solid content tubes for the centrifuge, rack to hold 100 ml solid content tubes, shipping containers suitable to transfer samples to the lab.

Once per day while drilling, a suction pit drilling fluid sample and MPSR unit discharge will be analyzed using the stacked-wet-sieve method described herein. Drilling fluid samples should be identified with Source/Date/Time. During the stacked-wet-sieve test, solid material is collected on three sieves and each flushed to a separate 100 ml glass receiver for analysis. This material should be identified with Sieve Size/Source/Date/Time.

Collect and properly label an 8 oz drilling fluid sample and an 8 oz split sample once per day while drilling. Take this sample at the same time and location as the suction pit mud check sample. Label samples with Location/Date/time (e.g. Suction/102407/1500). Collect MPSR unit discharge. Label samples with Location/Date/time (e.g. MP SR unit/102407/1500).

For each sample collected, load the wet-sieving device with the following clean sieves (in order of top to bottom): 500, 250, and 106 micron sieves. Tighten and secure sieves to prevent fluid bypass. Fill a clean glass tube to the 100 ml mark with the drilling fluid sample. Pour the entire contents of this glass tube into a bucket. Wash the mud residue in the tube, with base oil, into the bucket. Add 400 ml of base fluid to the bucket. Agitate the contents of the bucket with a stirring rod. Flush the bucket's contents over the sieve. Pour the entire contents of the bucket onto the sieving device, flushing the bucket with base oil as required to ensure its entire contents are transferred to the sieving device. Tap or vibrate the top of the wet-sieving device while it holds the sieves as necessary. This will help move along the material on the sieves as the sieves are being washed with base oil.

Using base oil, flush the wet-sieving device until the underflow of the device is clear of suspended sediment or other indications of sieve carry-through. This process may be accelerated by carefully suspending the wet-sieving device in a bucket of clean base oil, gently moving the device up and down, keeping the top of the device above the top of the base oil, and thereafter flushing as described above.

Carefully extract the three stacked sieves from the wet-sieving device without spilling any of solid material collected on each of the sieves. Place each sieve in a clearly labeled location to indicate its sieve size. Assign and label a clean 100 ml glass tube to each of these sieves, and place in a rack designed to hold them.

Carefully wash the material collected on each sieve into the designated 100 ml glass tube, using a squirt bottle of base oil to flush the screen, and a funnel to collect the entire material into the glass tube. Fill all tubes to the same height. It may be beneficial to load all three properly labeled 100 ml glass tubes before proceeding to the centrifuging step in order to optimize process time.

Load the hand-crank centrifuge with any two of these tubes and centrifuge for one minute. It may be beneficial to allow 5 seconds for the centrifuge to come up to a speed of one rotation per second, then holding that speed for the next 60 seconds.

Remove the tubes from the apparatus and record the apparent volume of solid material in mls for each tube. Replace either tube in the apparatus with the third, un-centrifuged tube, and repeat the spinning process. Remove the most recently added tube from the apparatus and record the apparent volume of solid material in mls. The data generated may influence factors such as the bulk density factor and possibly particle size distribution curves.

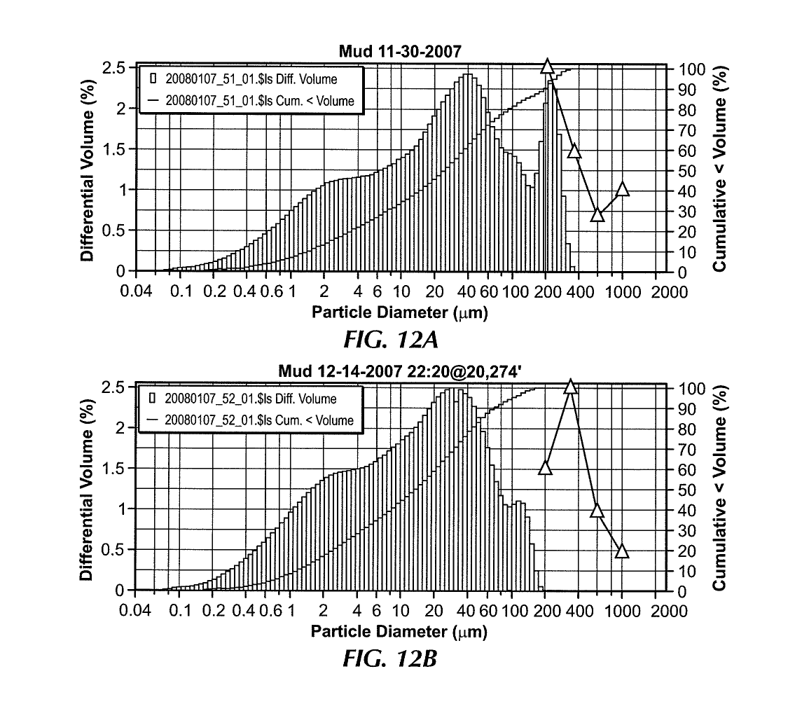

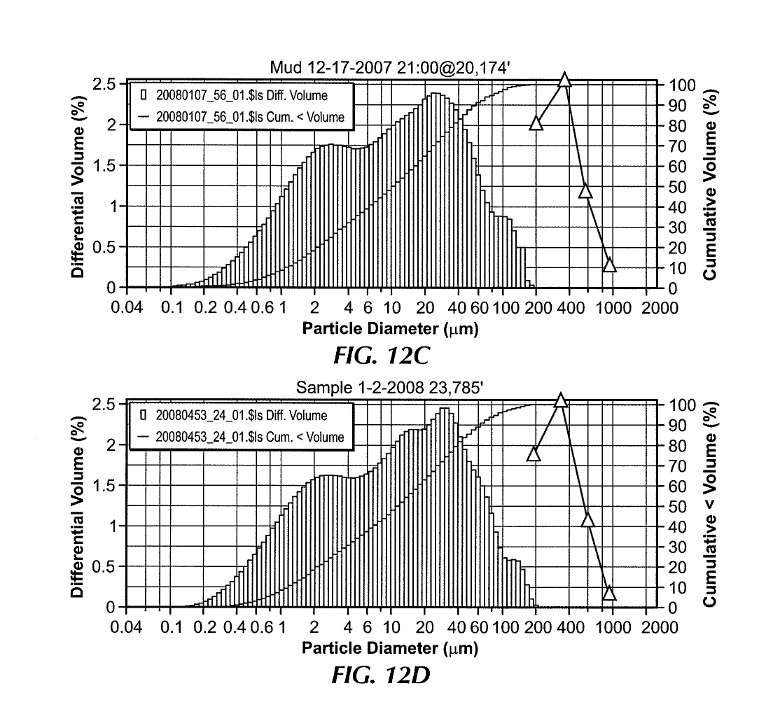

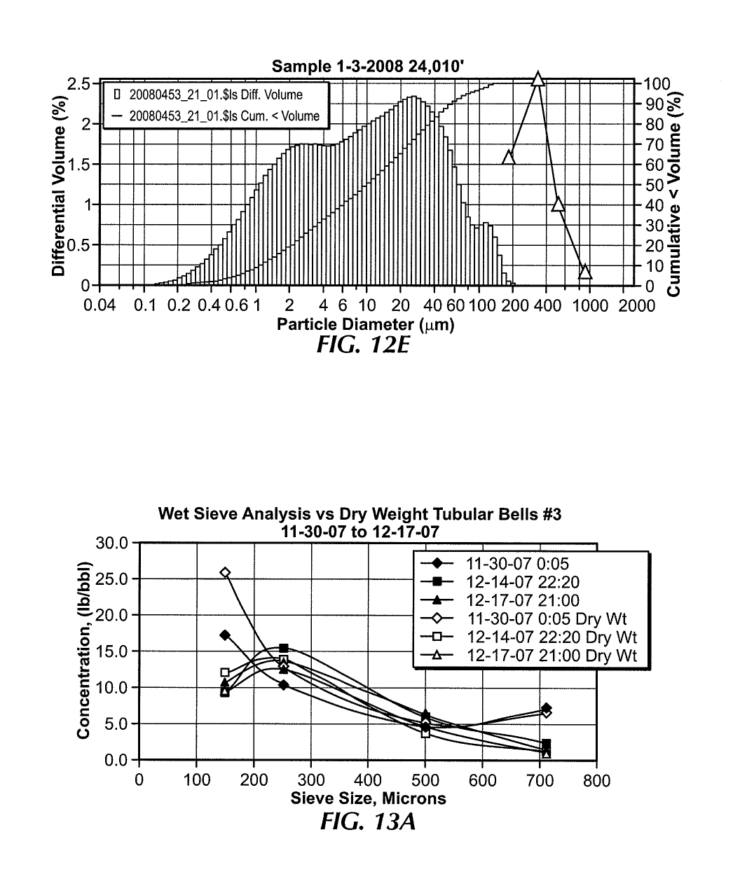

To validate this method, further analysis may be performed at a lab. For example, split samples may be sent to the lab and methods, such as dried weight, XRD, and Coulter PSD. FIGS. 12A-12E show the results of the Coulter PSD analysis versus the wet-sieve analysis. FIGS. 13A-13E show the results of the dry weight analysis versus the wet-sieve analysis.

Embodiments disclosed herein advantageously provide a method for determining the concentration of an additive, e.g., a bridging additive or a plugging agent, in wellbore fluid at a rig site. Additionally, embodiments disclosed herein provide apparatus for determining the concentration of the additive when an unknown quantity of the additive is being recovered and added to an active mud system. Further, embodiments disclosed herein provide improved methods and apparatus for maintaining particle size distribution of additives in a wellbore fluid by determining the particle size distribution or concentration of the additive recovered.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed:

1. A method of determining particle size distribution in a wellbore fluid, the method comprising:
collecting a volume of mud from a vibratory separator;
sampling a volume of the collected mud; and
testing the volume of collected mud with a test kit to determine the concentration of a sized additive in the mud.

2. The method of claim 1, further comprising determining a bulk density factor.

3. The method of claim 1, wherein the testing the volume of the collected mud comprises:
filling a first measuring tube of the test kit with the sampled mud;
adding clean base-oil to the first measuring tube;
shaking the first measuring tube;
pouring the mixture in the first measuring tube onto a screen of a sieve of the test kit;
returning material retained on the screen to the first measuring tube; and
placing the measuring tube in a centrifuge.

4. The method of claim 3, further comprising repeating the filling, adding, shaking, pouring, returning, and placing for a second measuring tube.

5. The method of claim 4, further comprising centrifuging the first and second measuring tubes.

6. The method of claim 5, further comprising estimating the percent volume of the sized additive by observing the material in the centrifuged measuring tubes.

7. The method of claim 6, further comprising determining a rate of recovery of the sized additive.

8. The method of claim 7, further comprising determining a quantity of sized additive recovered.

9. The method of claim 1, further comprising determining a bulk volume of the sized additive.

10. The method of claim 1, further comprising determining a collection time.

11. The method of claim 1, further comprising counting the number of volumes collected from the vibratory separator.

12. The method of claim 1, further comprising adding an amount of sized additive to the wellbore fluid based on the collecting, sampling, and testing.

13. A system for determining particle size distribution of a fluid, the system comprising:
a vibratory separator;
a meter configured to receive a separated material from the vibratory separator;
a counter configured to count the number of loads collected by the meter;
a test kit comprising a sieve and a measuring tube; and
a centrifuge configured to receive the measuring tube.

14. The system of claim 13, further comprising at least one adjustable spring set to receive a predetermined weight.

15. The system of claim 14, wherein the at least one adjustable spring is configured to move the meter when the predetermined weight is reached.

16. The system of claim 13, wherein the meter is disposed at a discharge end of the vibratory separator.

17. The system of claim 13, wherein the meter comprises a cylindrical body mounted in a frame, wherein the cylindrical body is configured to rotate within the frame.

18. The system of claim 13, wherein the test kit further comprises a funnel.

19. The system of claim 13, wherein the centrifuge is a hand-crank centrifuge.

20. The system of claim 13, further comprising a timing device.
